(19) United States
(12) Patent Application Publication
(10) Pub. No.: US 2025/0306622 A1
(43) Pub. Date: Oct. 2, 2025

(54) BANDGAP REFERENCE VOLTAGE GENERATION CIRCUIT AND SEMICONDUCTOR DEVICE INCLUDING SAME

(71) Applicant: LX SEMICON CO., LTD., Daejeon (KR)

(72) Inventor: Hyun Su KO, Daejeon (KR)

(73) Assignee: LX SEMICON CO., LTD., Daejeon (KR)

(21) Appl. No.: 19/107,388

(22) PCT Filed: Jul. 20, 2023
(86) PCT No.: PCT/KR2023/010478

§ 371 Date: Feb. 27, 2025

(30) Foreign Application Priority Data
Jul. 20, 2022 (KR) 10-2022-0089524
Jul. 19, 2023 (KR) 10-2023-0093572

(51) Int. Cl. G05F 3/24

(52) U.S. Cl. CPC G05F 3/24

(57) ABSTRACT

A bandgap reference voltage generation circuit, capable of stably generating a bandgap reference voltage by implementing a stable start-up operation regardless of changes in a driving environment, comprising: a start-up circuit that outputs a start-up signal when a first power voltage rises; and a bandgap reference core circuit in which an operation is enabled in response to the start-up signal and that generates and outputs the bandgap reference voltage, wherein the start-up circuit may include: a beta-multiplier reference circuit including a cascode current mirror circuit that forms a first current path and a second current path between a first power line and a second power line; a start-up output unit that outputs the start-up signal in response to a voltage of an output node of the second current path; and a comparator that compares the bandgap reference voltage with a target voltage to disable the operation of the start-up circuit.

### TECHNICAL FIELD

The present invention relates to a bandgap reference voltage generation circuit capable of reliably generating a bandgap reference voltage, and a semiconductor device having the same.

### BACKGROUND ART

A variety of electronic devices, including home appliances, smartphones, wearable devices, and the like, contain semiconductor devices such as micro controller units (MCU), memories, and the like.

A semiconductor device includes a bandgap reference voltage generation circuit that supplies stable internal power using power supplied from an external source.

The bandgap reference voltage generation circuit needs a characteristic capable of stably generating and supplying a reference voltage even when a driving environment such as a supply voltage, a process, and a temperature changes.

In recent, the bandgap reference voltage generation circuit may fail during the initial start-up operation due to changes in the driving environment, resulting in the output of abnormal reference voltages; therefore, stable start-up operation independent of changes in the driving environment is required.

### DISCLOSURE

### Technical Problem

The present invention provides a bandgap reference voltage generation circuit capable of stably generating a bandgap reference voltage by implementing a stable start-up operation independent of changes in the driving environment, and a semiconductor device having the same.

### Technical Solution

A bandgap reference voltage generation circuit according to an embodiment of the present invention may include: a start-up circuit configured to output a start-up signal when a first supply voltage rises; and a bandgap reference core circuit configured to be activated in response to the start-up signal, and to generate and output a bandgap reference voltage, wherein the start-up circuit may include: a beta-multiplier reference circuit including a cascode current mirror circuit forming a first current path and a second current path between a first power line and a second power line; a start-up output part configured to output the start-up signal in response to a voltage at an output node of the second current path; and a comparator configured to compare the bandgap reference voltage with a target voltage to inactivate an operation of the start-up circuit.

A semiconductor device according to an embodiment of the present invention may include: the bandgap reference voltage generation circuit; and a device circuit configured to receive and use the bandgap reference voltage from the bandgap reference voltage generation circuit.

### Effect of the Invention

According to an embodiment of the present invention, the bandgap reference voltage generation circuit may stably generate and output the bandgap reference voltage by allowing the start-up circuit to stably start up each circuit stage of the bandgap reference core circuit independent of a change in a driving environment such as a rise time of the supply voltage, a change in the process, and a change in the temperature by using the beta multiplier reference circuit.

According to an embodiment of the present invention, the bandgap reference voltage generation circuit may generate and output a bandgap reference voltage that is highly (insensitive) to power noise by using the start-up circuit by the Schmitt trigger circuit.

According to an embodiment of the present invention, the bandgap reference voltage generation circuit may terminate the operation of the start-up circuit when the bandgap reference voltage is higher than the target voltage by using a comparator, thereby implementing a stable start-up circuit independent of a change in a driving environment without additional power consumption.

According to an embodiment of the present invention, the semiconductor device including the bandgap reference voltage generation circuit may secure operation reliability by stably receiving and using the reference voltage independent of a change in the driving environment.

### BRIEF DESCRIPTION OF THE DRAWINGS

FIG. 1 is a block diagram schematically illustrating a semiconductor device according to one embodiment of the present invention.

FIG. 2 is a block diagram illustrating a bandgap reference voltage generation circuit according to one embodiment of the present invention.

FIG. 3 is a circuit diagram specifically illustrating a start-up circuit in the bandgap reference voltage generation circuit according to one embodiment of the present invention.

FIG. 4 is a circuit diagram specifically illustrating a bandgap reference core circuit in the bandgap reference voltage generation circuit according to one embodiment of the present invention.

FIG. 5 is a graph illustrating a start-up operation characteristic under a first driving condition of the bandgap reference voltage generation circuit according to one embodiment of the present invention.

FIG. 6 is a graph illustrating a start-up operation characteristic under a second driving condition of the bandgap reference voltage generation circuit according to one embodiment of the present invention.

### BEST MODE FOR CARRYING OUT THE INVENTION

Throughout the specification, the same reference numerals refer to substantially the same components. In the following description, detailed descriptions of configurations and features known in the art may be omitted if they are not relevant to the core configuration of the present invention. Terms used in this specification should be understood as follows.

The advantages and features of the present invention, and methods of achieving them will be apparent from the embodiments described in detail below in conjunction with the accompanying drawings. However, the present invention is not limited to the following embodiments, but may be implemented in various different forms; rather, the present embodiments are provided to make the description of the present invention complete and to allow those skilled in the art to fully understand the scope of the present invention, and the present invention is defined only within the scope of the appended claims.

Identical reference numerals may designate identical components throughout the description. Further, in describing the present invention, detailed descriptions of known related technologies may be omitted if it is considered to unnecessarily obscure the gist of the present invention.

The terms such as “including,” “having,” “comprising,” or the like used herein are generally intended to allow other components to be added unless the terms are used with the term “only.” References to components of a singular noun include the plural of that noun, unless specifically stated otherwise.

When describing a temporal contextual relationship is described, for example, such as “after,” “following,” “next to,” or “before,” it may also include non-contiguous cases unless “immediately” or “directly” is used.

The first, the second, and so on are used to describe various components, but these components are not limited by these terms. These terms are used only to distinguish one component from another. Therefore, the first component referred to herein may also be a second component within the technical idea of the present invention.

It should be understood that the term “at least one” includes any combination that may be presented from one or more relevant items. For example, the meaning of “at least one of the first item, the second item, and the third item” may mean each of the first item, the second item, and the third item as well as any combination of items that may be presented from two or more of the first item, the second item, and the third item.

Each of the features of various embodiments of the present invention may be coupled or combined with one another in whole or in part, and may be technologically interlocked and operated in various ways, and each of the embodiments may be carried out independently or in conjunction with one another.

Hereinafter, embodiments of the present invention will be described in detail with reference to the accompanying drawings.

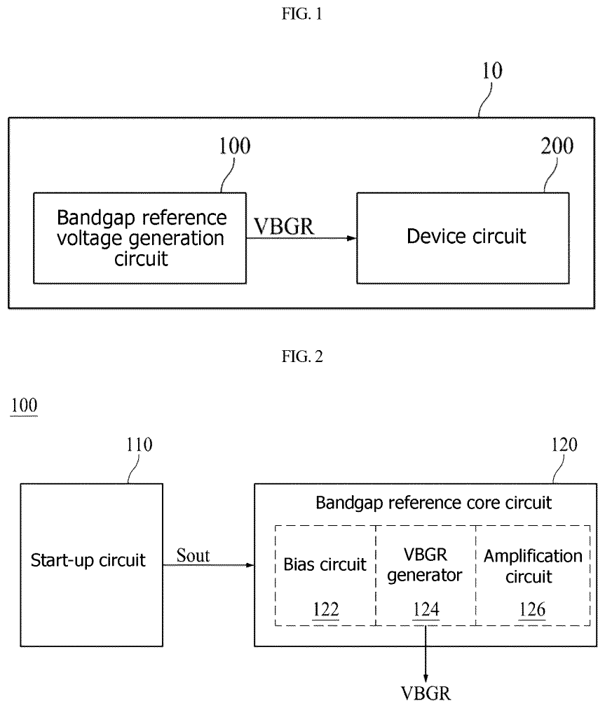

FIG. 1 is a block diagram schematically illustrating a semiconductor device according to one embodiment of the present invention.

Referring to FIG. 1, a semiconductor device 10 may include a bandgap reference voltage generation circuit 100 and a device circuit 200.

In one embodiment, the semiconductor device 10 may be an electronic device, such as a semiconductor chip, that generates data signals based on power supplied from an external source. For example, the semiconductor device 10 may be any one of a variety of semiconductor devices, such as micro controller units (MCU), processors, power management integrated circuits (PMIC), memories, etc. that are included in devices such as computers, smartphones, tablets, etc.

The device circuit 200 may include analog and digital circuits, such as analog circuits, digital circuits, analog-to-digital converters, and digital-to-analog converters, or combinations thereof, which require a bandgap reference voltage VBGR in the semiconductor device 10.

The bandgap reference voltage generation circuit 100 may stably generate the reference voltage VBGR using a supply voltage supplied from an external source regardless of a change in a driving environment including at least one of a change in a supply voltage, a change in a process, and a change in a temperature, and may output the reference voltage VBGR to the device circuit 200. The bandgap reference voltage generation circuit 100 may generate a normal reference voltage VBGR by implementing a stable start-up operation regardless of a change in the driving environment and output the normal reference voltage VBGR to the device circuit 200.

FIG. 2 is a block diagram illustrating the bandgap reference voltage generation circuit according to one embodiment of the present invention.

Referring to FIG. 2, the bandgap reference voltage generation circuit 100 may include a start-up circuit 110 and a bandgap reference core circuit 120.

The start-up circuit 110 may be activated when the supply voltage rises to output a start-up signal Sout, thereby reliably starting up the operation of the bandgap reference core circuit 120.

The start-up circuit 110 may stably start up each circuit stage of the bandgap reference core circuit 120 by using a beta-multiplier reference (BMR) circuit regardless of a change in a driving environment, such as a supply voltage, a process, and a temperature.

The start-up circuit 110 may stably start up the bandgap reference core circuit 120 regardless of power noise by using a Schmitt trigger circuit.

The start-up circuit 110 may monitor the bandgap reference voltage VBGR fed back from the bandgap reference core circuit 120 using a comparator. The comparator may deactivate the start-up circuit 110 after the bandgap reference voltage VBGR reaches a target voltage, thereby preventing the bandgap reference voltage VBGR from being output as an abnormal voltage and reducing power consumption.

The bandgap reference core circuit 120 may include a bias circuit 122, a bandgap reference voltage VBGR generator 124, and an amplification circuit 126. The bias circuit 122, the bandgap reference voltage VBGR generator 124, and the amplification circuit 126 may be activated in response to the start-up output signal Sout output from the start-up circuit 11.

The bias circuit 122 may generate a bias and allow current to flow through the reference voltage generator 124 by a current mirror circuit.

The amplification circuit 126 may perform gain amplification and feedback loop operations to make a pair of input nodes connected to the bandgap reference voltage VBGR generator 124 equipotential.

The reference voltage generator 124 may stably generate and output the bandgap reference voltage VBGR regardless of changes in driving environments such as a supply voltage, a process, and a temperature.

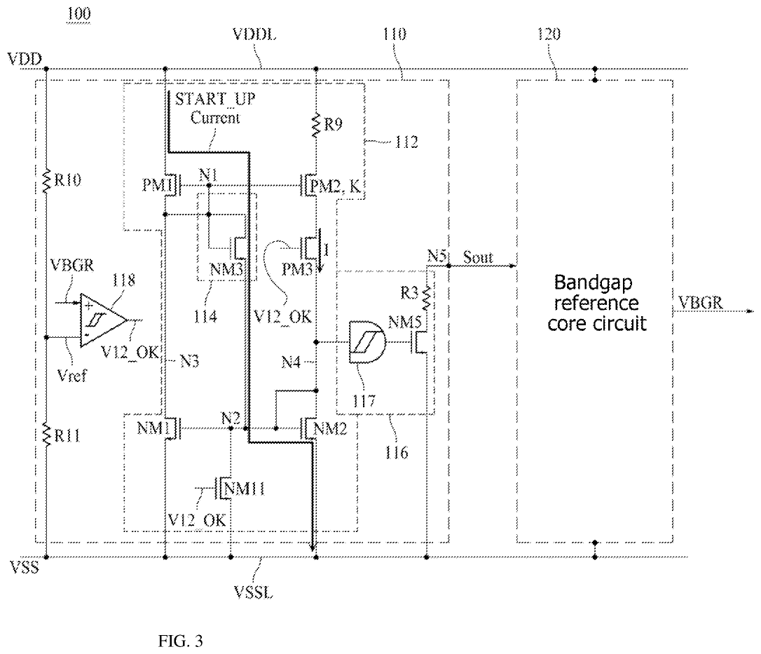

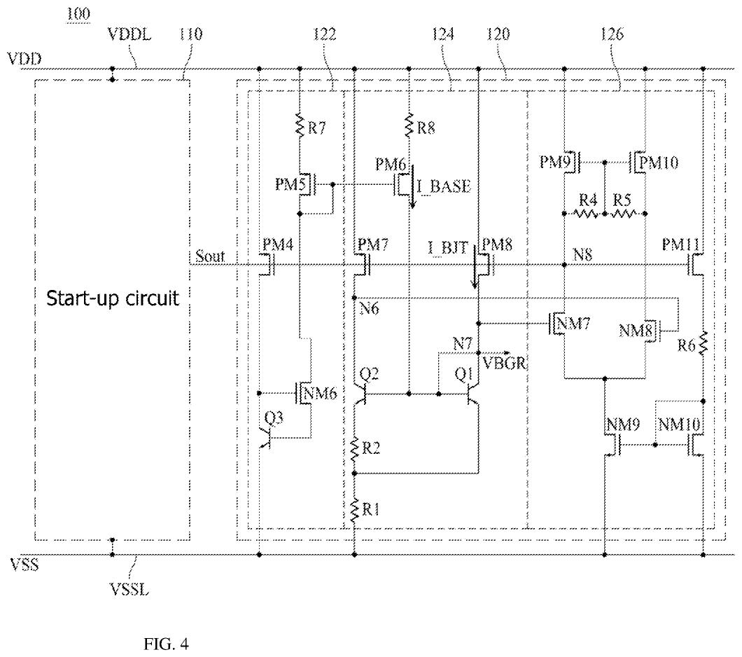

FIGS. 3 and 4 are detailed circuit diagrams illustrating a bandgap reference voltage generation circuit according to one embodiment of the present invention.

Referring to FIGS. 3 and 4, the bandgap reference voltage generation circuit 100 may include the start-up circuit 110 and the bandgap reference core circuit 120.

The start-up circuit 110 and the bandgap reference core circuit 120 are commonly connected to the first power line VDDL to which the first power voltage VDD is supplied and the second power line VSSL to which the second power voltage VSS is supplied. The first supply voltage VDD may be a positive supply voltage, and the second supply voltage VSS may be a ground voltage or a negative supply voltage.

Referring to FIG. 3, the start-up circuit 110 may include a beta-multiplier reference (BMR) circuit 112, a start-up control part 114, a start-up output part 116, and a comparator 118.

The BMR circuit 112 may have a cascode current mirror circuit structure in which first and second PMOS transistors PM1 and PM2 constituting a P-type metal-oxide-semiconductor (PMOS) current mirror circuit and first and second NMOS transistors NM1 and NM2 constituting an N-type metal-oxide-semiconductor (NMOS) current mirror circuit are connected in a cascode form between the first power line VDDL and the second power line VSSL, and may further include a resistor R9 connected between the first power line VDDL and a source terminal of the second PMOS transistor PM2.

A gate terminal of the first PMOS transistor PM1 and a gate terminal of the second PMOS transistor PM2 may be commonly connected to a first node N1, and a gate terminal of the first NMOS transistor NM1 and a gate terminal of the second NMOS transistor NM2 may be commonly connected to a second node N2. A gate terminal and a drain terminal of the first PMOS transistor PM1 may be commonly connected to the first node N1, and a gate terminal and a drain terminal of the second NMOS transistor NM2 may be commonly connected to the second node N2. A drain terminal of the first PMOS transistor PM1 and a drain terminal of the first NMOS transistor NM1 may be connected via a third node N3, and a drain terminal of the second PMOS transistor PM2 and a drain terminal of the second NMOS transistor NM2 may be connected via a fourth node N4. A first current path may be formed by the first PMOS transistor PM1 and the first NMOS transistor NM1, and a second current path may be formed by the second PMOS transistor PM2 and the second NMOS transistor NM2.

The BMR circuit 112 may further include a third PMOS transistor PM3 connected between the second NMOS transistor PM2 and the second PMOS transistor NM2, and an eleventh NMOS transistor NM11 connected between the second node N2 and the second power line VSSL. The second PMOS transistor PM2 and the eleventh NMMOS transistor NM11 have their gate terminals commonly connected to an output terminal of the comparator 112, and may perform a switching operation according to the output signal V12_OK of the comparator 112 to terminate the operation of the start-up circuit 110.

The start-up control part 114 may include a third NMOS transistor NM3 connected in a diode form between the first node N1 and the second node N2 of the BMR circuit 112 to start up the operation of the BMR circuit 112.

Specifically, when the first supply voltage VDD rises from 0 V to 5 V, the first PMOS transistor PM1, the third NMOS transistor NM3, and the second NMOS transistor NM2 act as diodes by the operation of the third NMOS transistor NM3 of the start-up control part 114 to allow the start-up START UP current to flow, so that the BMR circuit 112 may start up and operate.

After the BMR circuit 112 operates, a first current flows to the third node N3 through the first current path of the first PMOS transistor PM1 and the first NMOS transistor NM1, and a second current flows to the fourth node N4 through the second current path of the second PMOS transistor PM2 and the second NMOS transistor NM2. Based on the operating principle of the BMR circuit 112, the second current (I) flowing to the fourth node N may be determined as in Equation 1 below:

$$I = \frac{2}{R {9}^{2} \times β} \times {( 1 - \sqrt{\frac{1}{K}} )}^{2} \qquad [ Equation 1 ]$$

In Equation 1, R9 denotes a resistance value of the resistor R9, B denotes a current gain of the first PMOS transistor PM1, and K denotes an area multiple of the second PMOS transistor PM2 with respect to the first PMOS transistor PM1.

During operation of the BMR circuit 112, when the voltages at the third and fourth nodes N3 and N4 of the BMR circuit 112 become equal to each other as the first supply voltage VDD rises, the voltages at the first and second nodes N1 and N2 become equal to each other, thereby turning off the third NMOS transistor NM3. The fourth node N4 of the BMR circuit 112 may be represented as the output node of the BMR circuit 112.

The start-up output part 116 may output the start-up signal Sout to the bandgap reference core circuit 120 via the output node N5 in response to the voltage at the fourth node N4 of the BMR circuit 112. The start-up output part 116 may include a Schmitt trigger circuit 117, a fifth NMOS transistor NM5 as a switching element, and a resistor R3.

The Schmitt trigger circuit 117 may output a high signal when the voltage of the fourth node N4 becomes higher than the rising threshold voltage (Vth=0.8 V) of the Schmitt trigger circuit 117 by the operation of the BMR circuit 122. The fifth NMOS transistor NM5 may be turned on in response to the high output of the Schmitt trigger circuit 117. Accordingly, the start-up output part 116 may start up each circuit stage of the bandgap reference core circuit 120 by outputting the start-up output signal Sout in a low-state to the output node N5 through the turned-on fifth NMOS transistor NM and resistor R3. The output terminal of the Schmitt trigger circuit 117 may be represented by the BGR_start node.

The comparator 118 may compare the bandgap reference voltage VBGR supplied to the first input terminal (+), which is fed back from the bandgap reference core circuit 120, with the target voltage Vref, which is supplied to the second input terminal (−), to output the output signal V12_OK. The comparator 118 may terminate the operation of the start-up circuit 110 by the output signal V12_OK when the bandgap reference voltage VBGR generated by the bandgap reference core circuit 120 reaches and stabilizes at the target voltage Vref. The target voltage Vref may be generated through a voltage divider node between the voltage divider resistors R10 and R11 connected in series between the first power line VDDL and the second power line VSSL and may be supplied to the second input terminal (−) of the comparator 118.

When the bandgap reference voltage VBGR is lower than the target voltage Vref, the comparator 118 may output the output signal V12_OK in a low state. In response to the output signal V12_OK in the low state, the third PMOS transistor PM3 may be turned on to form a current path through which the current I flows to the fourth node N4 of the BMR circuit 112, and the eleventh NMOS transistor NM11 may be turned off.

When the bandgap reference voltage VBGR is stabilized and becomes higher than the target voltage Vref, the comparator 118 may output the output signal V12_OK in a high state to terminate the operation of the start-up circuit 110. In response to the high-state output signal V12_OK, the third PMOS transistor PM3 is turned off and the eleventh NMMOS transistor NM11 is turned on, thereby discharging the voltage at the second node N2 to the second power line VSSL. As the third PMOS transistor PM3 is turned off, the fourth node N4 may be in a low state, and the output of the Schmitt trigger circuit 117 may be switched to a low state. The fifth NMOS transistor NM5 may be turned off by the low state output of the Schmitt trigger circuit 117, and the operation of the start-up circuit 110 may be terminated.

Referring to FIG. 4, the bandgap reference core circuit 120 may include a bias circuit 122, a bandgap reference voltage VBGR generator 124, and an amplification circuit 126.

The bias circuit 122 may include a fourth PMOS transistor PM4 and a third bipolar junction transistor (BJT) Q3 connected in series between the first power line VDDL and the second power line VSSL, a resistor R7 and a fifth PMOS transistor PM5 and a sixth NMOS transistor NM6 connected in series between the first power line VDDL and a base terminal of the third BJT Q3.

A gate terminal of the fourth PMOS transistor PM4 may be connected to the output node N5 of the start-up circuit 110, a source terminal thereof may be connected to the first power line VDDL, and a drain terminal thereof may be connected to a collector terminal of the third BJT Q3.

The base terminal of the third BJT Q3 may be connected to a source terminal of the sixth NMOS transistor NM6, and an emitter terminal thereof may be connected to the first power line VSSL.

A gate terminal of the fifth PMOS transistor PM5 is connected to a drain terminal thereof, a source terminal thereof is connected to the first power line VDDL via the resistor R7, and the drain terminal thereof may be connected to a drain terminal of the sixth NMOS transistor NM6.

A gate terminal of the sixth NMOS transistor NM6 may be connected to the drain terminal of the fourth PMOS transistor PM4 and the collector terminal of the third BJT Q3.

The bandgap reference voltage VBGR generator 124 may include a sixth PMOS transistor PM6 forming a current mirror circuit, together with the fifth PMOS transistor PM5 of the bias circuit 122, seventh and eighth PMOS transistors PM7 and PM8 forming a cascode current mirror circuit between the first power line VDDL and the second power line VSSL, a second BJT Q2 and a first BJT Q1, and resistors R1, R2, and R8.

A gate terminal of the sixth PMOS transistor PM6 is connected to the gate terminal of the fifth PMOS transistor PM4, a source terminal thereof is connected to the first power line VDDL through the eighth resistor R8, and a drain terminal thereof may be connected to base terminals of the second BJT Q2 and the first BJT Q1.

A gate terminals of the seventh and eighth PMOS transistors PM7 and PM8 are connected to the output node N5 of the start-up circuit 110, and source terminals thereof may be connected to the first power line VDDL. A drain terminal of the seventh PMOS transistor PM7 may be connected to a collector terminal of the second BJT Q2 via a sixth node N6. A drain terminal of the eighth PMOS transistor PM8 may be connected to a collector terminal of the first BJT Q1 via a seventh node N7.

The base terminal of the second BJT Q2 may be connected to the base terminal of the first BJT Q1, and the emitter terminal thereof may be connected to the second power line VSSL through the resistors R2 and R1 in series.

The base terminal of the first BJT Q1 is connected to the collector terminal thereof, and the emitter terminal thereof may be connected to the connection node between the second resistor R2 and the first resistor R1.

The first to third BJTs Q1, Q2, and Q3 are NPN-type bipolar junction transistors, but PNP-type bipolar junction transistors may also be applied, without limitation.

The amplification circuit 126 may include ninth and tenth PMOS transistors PM9 and PM10 and resistors R4 and R5 connected to the first power line VDDL and forming a current mirror circuit, seventh and eighth NMOS transistors NM7 and NM8 forming an amplification input part connected to sixth and the seventh nodes N6 and N7 of the bandgap reference voltage generator 124, ninth and tenth NMOS transistors NM9 and NM10 forming a self-biasing circuit, an eleventh PMOS transistor PM11, and a resistor R6.

Gate terminals of the ninth and tenth PMOS transistors PM9 and PM10 may be connected to each other, source terminals thereof may be commonly connected to the first power line VDDL, and drain terminals thereof may be connected to drain terminals of the seventh and eighth NMOS transistors NM7 and NM8. The fourth resistor R4 may be connected between the gate terminal and the drain terminal of the ninth PMOS transistor PM9, and the fifth resistor R5 may be connected between the gate terminal and the drain terminal of the tenth PMOS transistor PM10.

The gate terminals of the seventh and eighth NMOS transistors NM7 and NM8 are input nodes of the amplification circuit 126 connected to the sixth and seventh nodes N6 and N7, and the source terminals thereof may be commonly connected to the drain terminals of the ninth NMOS transistor NM9.

A gate terminal of the ninth NMOS transistor NM9 may be connected to a gate terminal of the tenth NMOS transistor NM10, and source terminals of the ninth and tenth NMOS transistors NM9 and NM10 are commonly connected to the second power line VSSL, and the drain terminal and the gate terminal of the tenth NMOS transistor NM10 may be connected.

A gate electrode of the eleventh PMOS transistor PM11 may be connected to the output node N5 of the start-up circuit 110, a source terminal thereof may be connected to the first power line VDDL, and a drain terminal thereof may be connected to the drain terminal of the tenth NMOS transistor NM10 via the sixth resistor R6.

An eighth node N8 connected between the ninth PMOS transistor PM9 and the seventh NMOS transistor NM7 may be an output node of the amplification circuit 126, and may be commonly connected to the gate terminals of the fourth, seventh, eighth, and eleventh PMOS transistors PM4, PM7, PM8, and PM11 connected to the output node N5 of the start-up circuit 110.

In response to the start-up output signal Sout in a low state output from the start-up circuit 110, the fourth PMOS transistor PM4 of the bias circuit 122 of the bandgap reference core circuit 120, the seventh and eighth PMOS transistors PM7 and PM8 of the bandgap reference voltage VBGR generator 124, and the eleventh PMOS transistor PM11 of the amplification circuit 126 are turned on, allowing each circuit stage to start up and operate.

The bias circuit 122 may generate a bias by the activated loop of the fourth PMOS transistor PM4, the third BJT Q3, and the sixth NMOS transistor NM6, and generate a base current I BASE through the fifth and sixth PMOS transistors PM5 and PM6 to supply it to the bases of the second and first BJTs Q2 and Q1 of the bandgap reference voltage VBGR generator 124.

The bandgap reference voltage VBGR generator 124 may generate a current of the sixth node N6 flowing through the second BJT Q2 and a current I_BIT of the seventh node N7 flowing through the first BJT Q1 by the activated seventh and eighth PMOS transistors PM7 and PM8 and the base current I BASE.

The amplification circuit 126 may perform gain amplification and feedback loop operations to make the sixth and seventh nodes N6 and N7 equipotential by differentially amplifying the voltages of the sixth node N6 and the seventh node N7, and outputting the amplified signals through the eighth node N8 to regulate the currents of the fourth, seventh, eighth, and eleventh PMOS transistors PM4, PM7, PM8, and PM11.

The bandgap reference voltage VBGR generator 124 may generate the bandgap reference voltage VBGR using the current I_BJT flowing to the seventh node N7 and output it via the seventh node N7. The bandgap reference voltage VBGR may be determined as in Equation 2 below.

$$VBGR = {V}_{BE 1} + 2 Δ {V}_{BE} \times \frac{R 2}{R 1} \qquad [ Equation 2 ]$$

In Equation 2 above, VBE1 denotes the voltage between the base-emitter of the first BJT Q1, AVBE denotes a voltage difference between the voltage VBE2 between the base-emitters of the second BJT Q2 and the voltage VBE1 between the base-emitters of the first BJT Q1, and R2 and R1 denotes resistance values of the resistors R2 and R1 connected to the emitter terminals of the second and first BJT Q2 and Q1. Referring to Equation 2, the bandgap reference voltage VBGR generator 124 may generate the bandgap reference voltage VBGR independent of (insensitive to) a temperature change by canceling a temperature influence by a sum of an VBE1 item that is inversely proportional to an absolute temperature and a 2ΔVBE×(R2/R1) item that is proportional to the absolute temperature. Referring to Equation 2 above, it can also be seen that the bandgap reference voltage VBGR is independent of a process change and a change in the supply voltage VDD.

When the bandgap reference voltage VBGR becomes higher than the target voltage Vref, the operation of the start-up circuit 110 is terminated by the high output V12_OK of the comparator 118.

After the operation of the start-up circuit 110 is terminated, the bandgap reference core circuit 120 may stably generate and output the bandgap reference voltage VBGR, which is the target voltage Vref, by performing a feedback loop operation to make the sixth and seventh nodes N6 and N7 equipotential by the gain amplification operation of the amplification circuit 126. In this case, the first and second BJT Q1 and Q2 may secure a sufficiently large voltage VBE between the base and the emitter, and may generate and output the bandgap reference voltage VBGR, which is a target voltage, regardless of a rising time of the first supply voltage VDD, a process change, and a temperature change.

FIG. 5 is a graph illustrating a start-up operation characteristic in a first driving environment of a bandgap reference voltage generation circuit according to one embodiment of the present invention.

FIG. 5 illustrates an operation characteristic of the bandgap reference voltage generation circuit 100 according to one embodiment in a first driving environment with a rising time of the first supply voltage VDD of 1 ms, process corner TT (Typical-Typical), and temperature of 25° C.

Referring to FIGS. 3 to 5, while the first supply voltage VDD rises from 0 V to 5 V, the start-up circuit 110 may operate from the first time point t1 to the second time point t2 to output the start-up output signal Sout in a low state, and the bandgap reference core circuit 120 may generate and output the bandgap reference voltage VBGR rising from 0 V. It may be seen that when the bandgap reference voltage VBGR increases to be higher than the target voltage Vref=1.2 V at the second time point t2, the operation of the start-up circuit 110 is terminated by the high output V12_OK of the comparator 118, and the bandgap reference core circuit 120 may stably generate and output the bandgap reference voltage VBGR corresponding to the target voltage Vref=1.2 V.

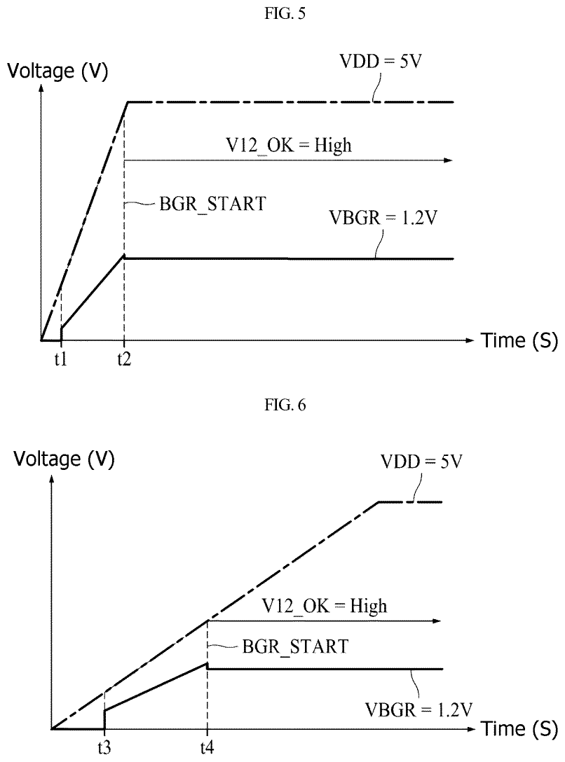

FIG. 6 is a graph illustrating a start-up operation characteristic in a second driving environment of a bandgap reference voltage generation circuit according to one embodiment of the present invention.

FIG. 6 illustrates an operation characteristic of the bandgap reference voltage generation circuit 100 according to one embodiment in a second driving environment with a rising time of the first supply voltage VDD of 2 s, a process corner SS (Slow-Slow), and a temperature of −40° C.

Referring to FIGS. 3, 4, and 6, while the first supply voltage VDD rises from 0 V to 5 V, the start-up circuit 110 may operate from the third time point t3 to the fourth time point t4 to output the start-up output signal Sout in a the low state, and the bandgap reference core circuit 120 may generate and output the bandgap reference voltage VBGR rising from 0 V. It may be seen that when the bandgap reference voltage VBGR increases to be higher than the target voltage Vref=1.2 V at the fourth time point t4, the operation of the start-up circuit 110 is terminated by the high output V12_OK of the comparator 118, and the bandgap reference core circuit 120 stably generates and outputs the bandgap reference voltage VBGR corresponding to the target voltage Vref=1.2 V.

As described above, the bandgap reference voltage generation circuit according to one embodiment of the present invention may stably generate and output the bandgap reference voltage by stably starting up each circuit stage of the bandgap reference core circuit using the beta multiplier reference circuit, independent of a change in a driving environment such as a rise time of the supply voltage, a process change, and a temperature change.

According to an embodiment of the present invention, the bandgap reference voltage generation circuit may generate and output a bandgap reference voltage that is highly (insensitive) to power noise by using the start-up circuit by the Schmitt trigger circuit.

According to an embodiment of the present invention, the bandgap reference voltage generation circuit may terminate the operation of the start-up circuit when the bandgap reference voltage is higher than the target voltage by using a comparator, thereby implementing a stable start-up circuit independent of a change in a driving environment without additional power consumption.

According to an embodiment of the present invention, the semiconductor device including the bandgap reference voltage generation circuit may secure operation reliability by stably receiving and using the reference voltage independent of a change in the driving environment.

A bandgap reference voltage generation circuit according to an embodiment of the present invention may include: a start-up circuit configured to output a start-up signal when a first supply voltage rises; and a bandgap reference core circuit configured to be activated in response to the start-up signal, and to generate and output a bandgap reference voltage, wherein the start-up circuit may include: a beta-multiplier reference circuit including a cascode current mirror circuit forming a first current path and a second current path between a first power line and a second power line; a start-up output part configured to output the start-up signal in response to a voltage at an output node of the second current path; and a comparator configured to compare the bandgap reference voltage with a target voltage to inactivate an operation of the start-up circuit.

The beta-multiplier reference circuit may include: a PMOS current mirror and an NMOS current mirror connected in a cascode form between the first and second power lines; and

a start-up control part connected between a first node connected to a gate terminal of the PMOS current mirror and a second node connected to a gate terminal of the NMOS current mirror, and configured to start up an operation of the beta-multiplier reference circuit.

The PMOS current mirror may include: a first PMOS transistor included in the first current path and having a gate terminal and a drain terminal connected to the first node; a second PMOS transistor included in the second current path, having a gate terminal connected to the first node, and having an area K times (where K is a positive number) larger than the area of the first PMOS transistor; and a resistor connected in series between the first power line and the second PMOS transistor, wherein the current flowing in the second current path may be determined by a current gain β of the first PMOS transistor, a multiple of the K, and a resistance value of the resistor.

The NMOS current mirror may include: a first NMOS transistor included in the first current path and having a gate terminal connected to the second node; and a second NMOS transistor included in the second current path and having a gate terminal and a drain terminal connected to the second node.

The start-up control part may include: a third NMOS transistor connected in the form of a diode between the first node and the second node.

The start-up control part may be configured to start up the beta-multiplier reference circuit by the first PMOS transistor, the third NMOS transistor, and the second NMOS transistor, which are connected in the form of a diode, when the first power voltage supplied to the first power line is rising.

The third NMOS transistor may be configured to be turned off when a voltage of a third node connected between the first PMOS transistor and the first NMOS transistor is equal to a voltage of the output node connected between the second PMOS transistor and the second NMOS transistor when the first supply voltage is rising.

The beta-multiplier reference circuit may further include: a third PMOS transistor configured to be controlled by an output of the comparator and connected between the second NMOS transistor and the second PMOS transistor.

The beta-multiplier reference circuit may further include: an eleventh NMOS transistor configured to be controlled by an output of the comparator and connected between the second node and the second power line.

The comparator may be configured to: turn on the third PMOS transistor and turn off the eleventh NMOS transistor when the bandgap reference voltage is lower than the target voltage, and turn off the third PMOS transistor and turn on the eleventh NMOS transistor when the bandgap reference voltage is higher than the target voltage.

The start-up output part may include: a Schmitt trigger circuit connected to the output node between the third PMOS transistor and the second NMOS transistor, a fifth NMOS transistor configured to be controlled by an output of the Schmitt trigger circuit and connected between an output node of the start-up circuit and the second power line; and a resistor connected between the output node of the start-up circuit and the fifth NMOS transistor.

The start-up output part may be configured to output the start-up signal through the fifth NMOS transistor in response to the output of the Schmidt trigger circuit when the voltage of the output node of the beta-multiplier reference circuit is higher than the rising threshold voltage of the Schmidt trigger circuit.

The third PMOS transistor may be turned off in response to the output of the comparator, the fifth NMOS transistor is turned off in response to the output of the Schmitt trigger circuit.

The bandgap reference core circuit may include: a bias circuit configured to generate a bias and generate a base current through the current mirror circuit when it is activated by the startup signal; a bandgap reference voltage generator configured to generate a bipolar junction transistor current using the base current, and to generate the bandgap reference voltage using the bipolar junction transistor current when it is activated by the start-up signal; and an amplification circuit configured to differentially amplify voltages of sixth and seventh nodes of the bandgap reference voltage generator to feed back to the bias circuit and the bandgap reference voltage generator, and to control the bipolar junction transistor current when it is activated by the start-up signal.

A semiconductor device according to an embodiment of the present invention may include: the bandgap reference voltage generation circuit; and a device circuit configured to receive and use the bandgap reference voltage from the bandgap reference voltage generation circuit.

Those skilled in the art to which the present invention belongs will understand that the present invention described above may be implemented in other specific forms without changing its technical idea or essential features.

Therefore, it should be understood that the embodiments described above are illustrative in all aspects and do not limit the present invention. The scope of the present invention is represented by the following claims rather than the above detailed description, and it should be construed that all changes or modifications derived from the meaning and scope of the claims and their equivalent concepts are included within the scope of the present invention.

### Mode of Practing the Invention

The various modes of practicing the invention have been described in the previous subheadings, ‘Best Modes for Carrying Out the Invention’.

### INDUSTRIAL APPLICABILITY

The present invention is applicable to a wide variety of electronic devices related to semiconductors and thus has industrial applicability.

1. A bandgap reference voltage generation circuit comprising:
a start-up circuit configured to output a start-up signal when a first supply voltage rises; and
a bandgap reference core circuit configured to be activated in response to the start-up signal, and to generate and output a bandgap reference voltage,
wherein the start-up circuit includes:
a beta-multiplier reference circuit including a cascode current mirror circuit forming a first current path and a second current path between a first power line and a second power line;
a start-up output part configured to output the start-up signal in response to a voltage at an output node of the second current path; and
a comparator configured to compare the bandgap reference voltage with a target voltage to inactivate an operation of the start-up circuit.

2. The bandgap reference voltage generation circuit of claim 1, wherein the beta-multiplier reference circuit includes:
a PMOS current mirror and an NMOS current mirror connected in a cascode form between the first and second power lines; and
a start-up control part connected between a first node connected to a gate terminal of the PMOS current mirror and a second node connected to a gate terminal of the NMOS current mirror, and configured to start up an operation of the beta-multiplier reference circuit.

3. The bandgap reference voltage generation circuit of claim 2, wherein the PMOS current mirror includes:
a first PMOS transistor included in the first current path and having a gate terminal and a drain terminal connected to the first node;
a second PMOS transistor included in the second current path, having a gate terminal connected to the first node, and having an area K times (where K is a positive number) larger than the area of the first PMOS transistor; and
a resistor connected in series between the first power line and the second PMOS transistor,
wherein the current flowing in the second current path is determined by a current gain β of the first PMOS transistor, a multiple of the K, and a resistance value of the resistor.

4. The bandgap reference voltage generation circuit of claim 3, wherein the NMOS current mirror includes:
a first NMOS transistor included in the first current path and having a gate terminal connected to the second node; and
a second NMOS transistor included in the second current path and having a gate terminal and a drain terminal connected to the second node.

5. The bandgap reference voltage generation circuit of claim 4, wherein the start-up control part includes:
a third NMOS transistor connected in the form of a diode between the first node and the second node.

6. The bandgap reference voltage generation circuit of claim 5, wherein the start-up control part is configured to: start up the beta-multiplier reference circuit by the first PMOS transistor, the third NMOS transistor, and the second NMOS transistor, which are connected in the form of a diode, when the first power voltage supplied to the first power line is rising.

7. The bandgap reference voltage generation circuit of claim 5, wherein the third NMOS transistor is turned off when a voltage of a third node connected between the first PMOS transistor and the first NMOS transistor is equal to a voltage of the output node connected between the second PMOS transistor and the second NMOS transistor when the first supply voltage is rising.

8. The bandgap reference voltage generation circuit of claim 4, wherein the beta-multiplier reference circuit further includes:
a third PMOS transistor configured to be controlled by an output of the comparator and connected between the second NMOS transistor and the second PMOS transistor.

9. The bandgap reference voltage generation circuit of claim 8, wherein the beta-multiplier reference circuit further includes:
an eleventh NMOS transistor configured to be controlled by an output of the comparator and connected between the second node and the second power line.

10. The bandgap reference voltage generation circuit of claim 9, wherein the comparator is configured to:
turn on the third PMOS transistor and turn off the eleventh NMOS transistor when the bandgap reference voltage is lower than the target voltage, and
turn off the third PMOS transistor and turn on the eleventh NMOS transistor when the bandgap reference voltage is higher than the target voltage.

11. The bandgap reference voltage generation circuit of claim 8, wherein the start-up output part includes:
a Schmitt trigger circuit connected to the output node between the third PMOS transistor and the second NMOS transistor;
a fifth NMOS transistor configured to be controlled by an output of the Schmitt trigger circuit and connected between an output node of the start-up circuit and the second power line; and
a resistor connected between the output node of the start-up circuit and the fifth NMOS transistor.

12. The bandgap reference voltage generation circuit of claim 11, wherein the start-up output part is configured to output the start-up signal through the fifth NMOS transistor in response to the output of the Schmidt trigger circuit when the voltage of the output node of the beta-multiplier reference circuit is higher than the rising threshold voltage of the Schmidt trigger circuit.

13. The bandgap reference voltage generation circuit of claim 12, when the third PMOS transistor is turned off in response to the output of the comparator, the fifth NMOS transistor is turned off in response to the output of the Schmitt trigger circuit.

14. The bandgap reference voltage generation circuit of claim 11, wherein the bandgap reference core circuit includes:
a bias circuit configured to generate a bias and generate a base current through the current mirror circuit when it is activated by the startup signal;
a bandgap reference voltage generator configured to generate a bipolar junction transistor current using the base current, and to generate the bandgap reference voltage using the bipolar junction transistor current when it is activated by the start-up signal; and
an amplification circuit configured to differentially amplify voltages of sixth and seventh nodes of the bandgap reference voltage generator to feed back to the bias circuit and the bandgap reference voltage generator, and to control the bipolar junction transistor current when it is activated by the start-up signal.

15. A semiconductor device comprising:
the bandgap reference voltage generation circuit of claim 1; and
a device circuit configured to receive and use the bandgap reference voltage from the bandgap reference voltage generation circuit.
